(19) United States
(12) Patent Application Publication
(10) Pub. No.: US 2005/0286706 A1
(43) Pub. Date: Dec. 29, 2005

(54) Recorded call playback

(76) Inventor: David Fuller, Noblesville, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/873,370

(22) Filed: Jun. 22, 2004

(51) Int. Cl. H04M 5/00; H04M 3/00

(52) U.S. Cl. 379/265.02

(57) ABSTRACT

A computer system and method is disclosed for playing a recording to multiple parties to a communication. An automatic communication distributor establishes a communication channel between a contact center agent and a customer. The contact center agent selects a previously saved recording from a recording store and plays this recording over the communication channel so that both the contact center agent and the customer receive it. This recording can be aural in the case of a telephonic form of communication channel and/or visual in the case of an image-based form of communication channel. A few non-limiting examples of recordings include telephone calls, still images, moving pictures, and video communications.

### BACKGROUND

The present invention relates to communication processing, and more particularly, but not exclusively, relates to playing recordings to two or more parties communicating with one another.

In a call center, an agent typically communicates with customers through in-bound calls, out-bound calls, or both. This communication is often by voice using a telephone handset or headset component of the agent's workstation. Usually, the workstation also includes a computer terminal or personal computer to interface with various application modules. These modules provide the agent information directed to the particular customer service involved. In one common application, a customer's account information is provided on a display viewable by the agent. In recent years, call centers have become more generalized, utilizing other forms of communication in addition to or in lieu of telephone calls. These more general communication contact centers often include applications to accommodate several different communication media, such as telephone call, fax, pager, and computer network based forms.

The time it takes agents to handle a communication with a customer, and the lapse of time between customer contacts are factors that influence the efficiency of contact center operations. Although sometimes at odds with efficiency goals, it is also generally desirable to provide customers as favorable an impression as possible with regard to contact center transactions. In an attempt to strike a balance between these interests, certain communication applications include delivering a pre-recorded message to a customer before and/or after two-way communication between the agent and customer. Unfortunately, such approaches do not facilitate and/or recognize certain desirable communication scenarios. Thus, there is a continuing demand for further advancements in the call center technology area.

### SUMMARY

One embodiment of the present invention is a unique communication technique. Other embodiments include unique systems, apparatus, devices, and methods for processing communications.

A further embodiment includes a technique for playing a recording to multiple parties to a communication. This recording can be selected by the one of parties based on the context of the communication. In one particular form, the parties communicate by telephone and the recording is selected based on information learned from the communication.

Another embodiment includes: operating an automatic communication distributor to establish a communication channel between a contact center agent and a customer. In response, the contact center agent selects a recording from among a number of different recordings and plays this recording over the communication channel so that both the contact center agent and the customer receive it. This recording can be aural in the case of a telephonic form of communication channel and/or visual in the case of an image-based form of communication channel. The communication channel can be based on standard Public Switched Telephone Network (PSTN) telephone lines, wireless telephone, and/or a publicly accessible computer network, such as the internet, to provide an aurally perceived communication, still image, moving picture, or video communication, to name just a few examples.

Accordingly, one object of the present invention is to provide a unique communication technique.

Another object of the present invention is to provide a unique system, apparatus, device, or method for processing communications.

Further forms, objects, features, aspects, benefits, advantages, and embodiments of the present invention shall become apparent from the detailed description and drawings provided herewith.

### BRIEF DESCRIPTION OF THE DRAWINGS

FIG. 1 is a schematic view of a communication system.

FIG. 2 is a flowchart of one procedure that can be implemented with the system of FIG. 1.

FIG. 3 is a partial diagrammatic view of a contact center agent station of FIG. 1 with Graphical User Interface (GUI) controls to selectively playback a recording in accordance with the procedure of FIG. 2.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

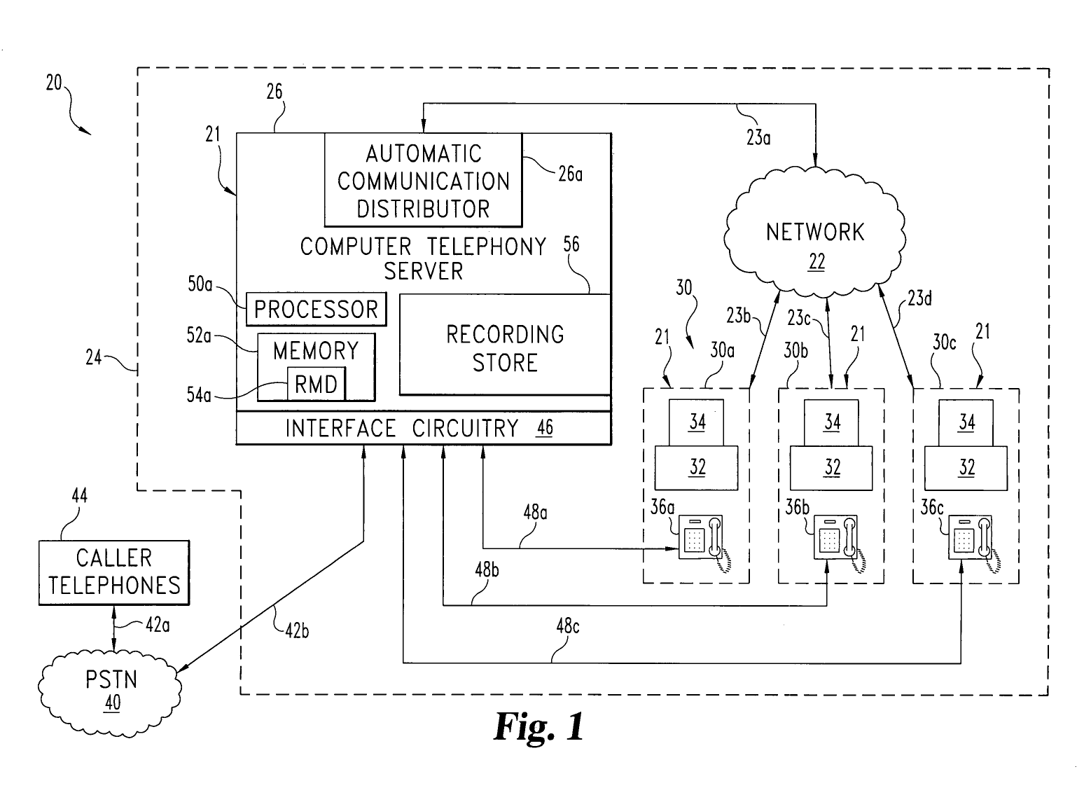

FIG. 1 is a diagrammatic view of computer system 20 of one embodiment of the present invention. Computer system 20 includes computer network 22. Computer network 22 couples together a number of computers 21 over network pathways 23. More specifically, system 20 has one or more servers, including Computer Telephony (CT) server 26 and agent client workstations 30a, 30b, and 30c. CT server 26, alternatively referred to as communication server 26, includes hardware and/or software to define an Automated Commercial Distributor (ACD) 26a. While computers 21 are each illustrated as being a server or client, it should be understood that any of computers 21 may be arranged to include both a client and server. Furthermore, it should be understood that while four computers 21 are illustrated, more or fewer may be utilized in alternative embodiments.

CT server 26 includes one or more processors or CPUs 50a and memory 52a that can be comprised of one or more types. Memory 52a includes a removable memory device (RMD) 54a. Although not shown to preserve clarity, each computer 21 of system 20 includes one or more processors or CPUs and one or more types of memory. Each processor may be comprised of one or more components configured as a single unit. Alternatively, when of a multi-component form, a processor may have one or more components located remotely relative to the others. Such components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disk memory (such as a DVD or CD ROM); a magnetically encoded hard disk, floppy disk, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to interface circuitry 46 of server 26 by pathway 42b. For this embodiment, interface circuitry 46 is a computer controlled switch that is in the form of one or more telephone communication processing boards, such as those offered by INTEL Corporation under the DIALOGIC® brand, or by ACULAB. Caller telephones 44 are coupled to PSTN 40 by pathway 42a. Interface circuitry 46 is also coupled to telephone communication devices 36a, 36b, and 36c (collectively designated as telephones 36) by pathways 48a, 48b, and 48c. For the sake of clarity, interface circuitry 46 is shown coupled to multiple telephones 36. However, is should be understood that each of telephones 36 may be coupled to one or more interface circuitries and that one or more interface circuitries 46 may be located at one or more physical locations. Interface circuitry 46 may be arranged in the form of hardware for a Private Branch Exchange (PBX), predictive dialer, Automatic Communication Distributor (ACD), a combination of these, or another switching configuration as would occur to those skilled in the art. Telephones 36 may be in the form of a handset, headset, or other arrangement as would occur to those skilled in the art. Telephones 36a, 36b, and 36 are each associated with a different one of agent workstations 30a, 30b, and 30c, respectively (collectively designated agent workstations 30). Agent workstations 30 each include an agent computer 32 coupled to a display 34. Agent computers 32 may be of the same type, or a heterogeneous combination of different computing devices. Likewise, displays 34 may be of the same type, or a heterogeneous combination of different visual devices. Although not shown to preserve clarity, each agent workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22. It should also be recognized that computer network 22 may include one or more elements of PSTN 40. Indeed, in an alternate embodiment, PSTN 40 and computer network 22 are provided as a common network.

In one embodiment, system 20 operates as a communication contact center 24 at one or more physical locations that are remote from one another with server 26 being configured as a communication contact center server host. While ACD 26a is shown defined by server 26, in other embodiments may only partially be defined by server 26 and/or defined with one or more other servers. Alternatively or additionally, the recorded communications could be stored on server 26 and/or on a separate server. Server 26 also defines recording store 56 to store recorded communications. Likewise, a common server (such as server 26) or other servers can be provided for computer network management, e-mail, facsimile, and the like. Agent workstations 30a, 30b, and 30c are each arranged as a communication contact center client host. Additional telephones 36 may be connected to interface circuitry 46 that each correspond to an additional client host to provide more agent workstations 30 (not shown). Typically communication contact center applications of system 20 would include many more agent workstations of this type at one or more physical locations, but only a few have been illustrated in FIG. 1 to preserve clarity. Also, one or more servers 26 may be configured as a communication contact center server host at one or more physical locations.

Alternatively or additionally, system 20 may be arranged to provide for distribution and routing of a number of different forms of communication, such as telephone calls, voice mails, faxes, e-mail, web chats, web call backs, and the like. Furthermore, business/customer data associated with various communications may be selectively accessed with system 20. This data may be presented to an agent at each agent workstation 30 by way of monitor 34 operatively coupled to the corresponding agent computer 32. Alternatively or additionally, this presented data may include details about a previously recorded communication that is stored in recorded communications store 56 or another location.

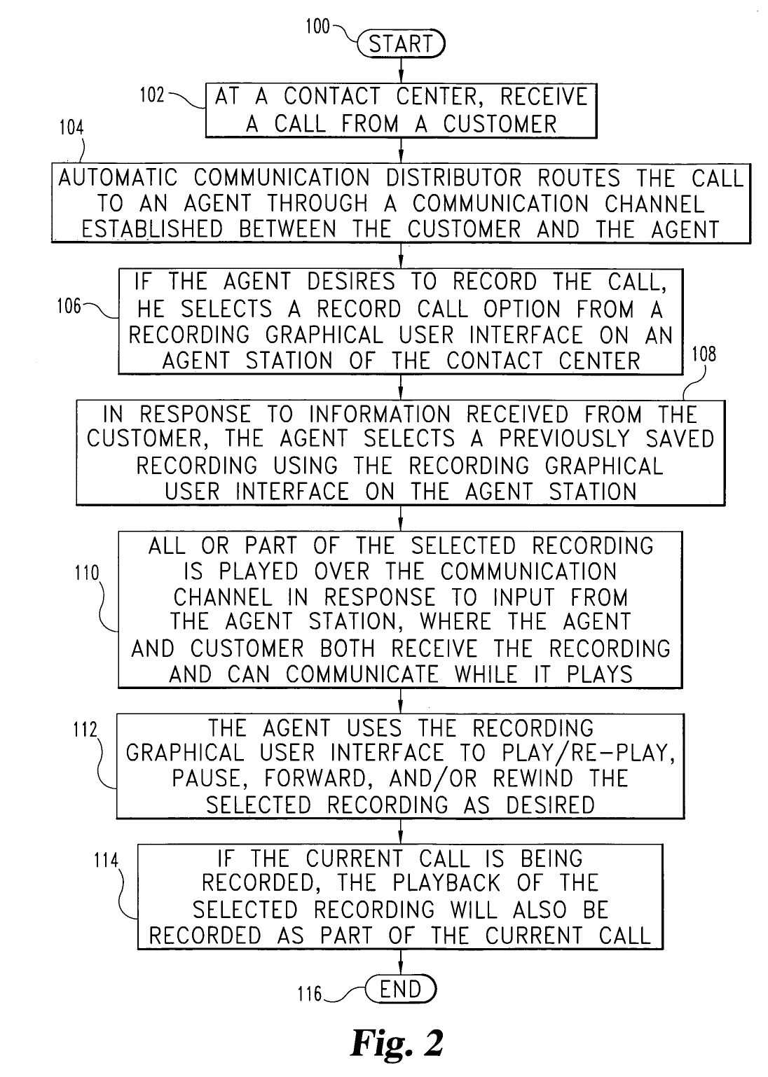

Referring additionally to FIG. 2, one embodiment for implementation with system 20 is illustrated in flow chart form as routing procedure 100, which demonstrates a process for playing a recording to multiple parties of the communication. In one form, procedure 100 is at least partially implemented in the operating logic of system 20, particularly server 26. Such logic can be in the form of software instructions, firmware instructions, dedicated hardware, or a combination of these. Procedure 100 begins with receiving at a communication contact center a telephone call from a customer (stage 102). Automatic communication distributor server 26 routes the call to an agent through a communication channel established between the customer and an agent (stage 104). If the agent desires to record the call, a record call option is selected by the agent from a recording graphical user interface on an agent station 30 of the contact center (stage 106). Alternatively or additionally, a setting can be specified from a recording graphical user interface on an agent station 30 that will automatically record all calls, or all calls of a certain type. The setting for recording all calls or all calls of a certain type can be specified by an administrator to apply to multiple agent stations 30 or it can be set by a user to apply to calls for a particular agent station 30.

As the agent and customer communicate, the customer may say something (e.g., spoken information) that causes the agent to use the recording graphical user interface on the agent station 30 to retrieve and play a previously saved recording that is stored in recorded communications store 56 (stage 108). This previously saved recording might be a prior telephone call or other communication from the customer that is relevant to the present discussion. The current call is placed on a telephony bus while automatic communication distribution server 26 retrieves the selected recording from recorded communications store 26, opens a separate line to play the recording on, and then conferences the separate line to the agent and customer call. All or part of the selected recording is then played over the communication channel, where the agent and customer both receive the recording and can communicate while it plays (stage 110). The agent uses the recording graphical user interface to play/re-play, pause, fast forward, repeat, and/or rewind the selected recording as desired (stage 112). Typically, such playback features can be used to locate and repeat one or more selected recording segments while skipping over one or more others. If the agent selected the option to record the current call (at stage 106), then the play-back of the selected recording will also be recorded as part of the current call (stage 114). The process then ends at stage 116. The agent can repeat this process multiple times to play back more than one previously saved communication based on information received from the customer. Alternatively or additionally, the agent can select an option to play a selected recording through agent workstation 30 so only the agent hears that recording playback.

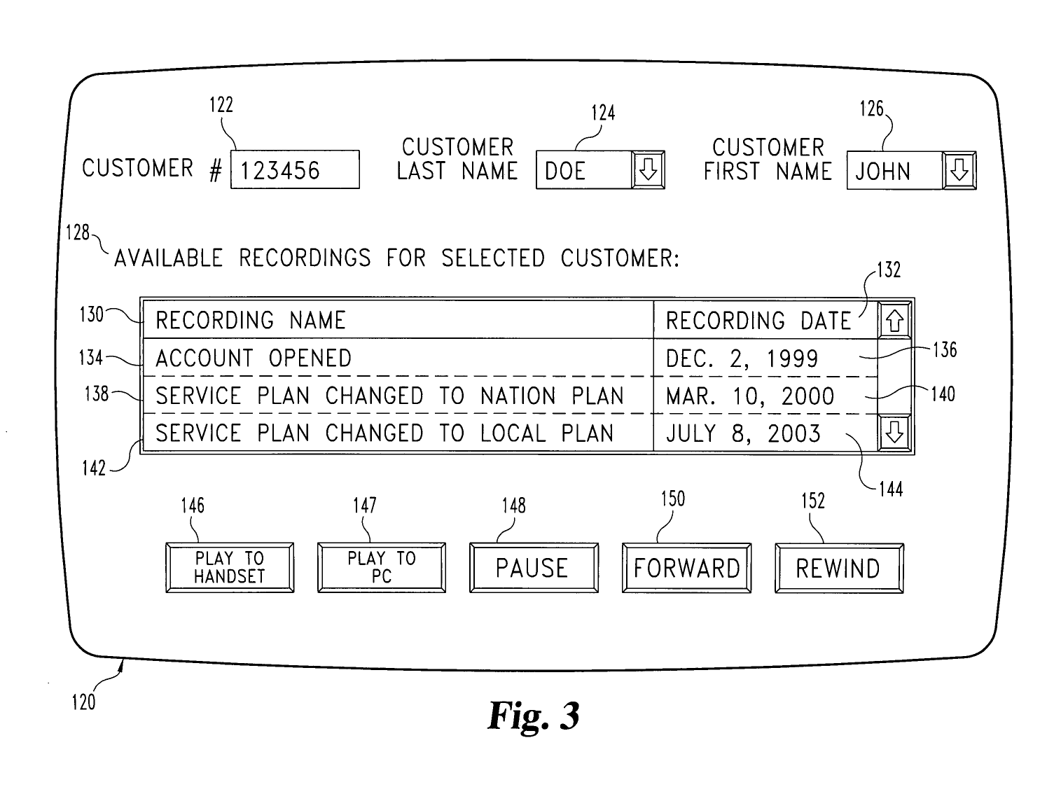

FIG. 3 is a partial diagrammatic view of the contact center agent station 30 of FIG. 1 with Graphical User Interface (GUI) controls to selectively playback a recording in accordance with the procedure of FIG. 2. These recordings are managed with server 26 and accessed in store 56. Customer number 122, last name 124, and/or first name 126 of recording GUI 120 can be used to retrieve a customer record. After locating a customer record, a list of available recordings for the selected customer 128 is displayed to the agent. The recording name 130 and recording date 132 for each recording are displayed. For example, FIG. 3 shows that John Doe has three recorded communications. The first one was when his account was opened 134 on Dec. 2, 1999 (136). The second was when he changed his service plan to a national plan 138 on Mar. 10, 2000 (140). The last recording is when he changed his service to a local plan 142 on Jul. 8, 2003 (144). If the agent selects one of the available recordings 128, then he can select the play to handset option 146 to play the recording over the communication channel with the customer. The agent can also select the play to PC option 147 to play the recording through agent workstation 30 so that the customer does not hear the playback. A pause option 148, fast forward option 150, and a rewind option 152 are also provided to allow the agent to pause, forward, and/or rewind the selected recording. One of skill in the art will appreciate that this screen could be designed in various ways that would to allow for retrieval and playback control of a previously saved communication.

A hypothetical scenario will be described with reference to FIGS. 1-3. For example, suppose that contact center 20 provides customer service to wireless customers. The customer, John Doe, may be calling (stage 102) to complain about being charged for roaming charges when the customer believes he was on a nationwide calling plan. The call is routed to an agent by Automatic Communication Distributor 24 (stage 104). After receiving this information (complaint) from the customer (stage 106), the agent uses a recording GUI 120 on agent workstation 30 to input one or more customer identifiers 122, 124, and/or 126 to look up the previously stored recordings for that customer's account (stage 108).

The agent discovers the most recent recording in the list of available recordings 128 shows that the customer switched to a local plan that does not include roaming 142. Specifically, recording 142 is of the customer's own spoken instructions that authorize the switch. The agent can select that prior recording 142 and select the play option 146 to play recording 142 to the customer to help explain that the roaming charges were incurred due to the customer's own decision to change to the local plan. The recording is retrieved from recorded communications store 56 and then played over the communication channel so that both the agent and the customer can hear the recording and continue communicating (stage 110), even during recording playback. The agent can use the recording GUI 120 to play/re-play, pause, fast forward, repeat and/or rewind the recordings as desired (stage 112).

Alternatively or additionally, the previously described methods, devices, systems, and/or apparatus of the present application may be used in a setting or institution other than a contact center. In one example, parties other than call center customer service agents utilize the teachings of the present application to record calls among two or more persons and selectively playback such recorded calls. In another example, instead of contact center agents, one or more employees of a business or other institution operate a phone system arranged to record calls, select among previous call recordings, and playback one or more selected recordings in accordance with the teachings of the present application. Calls recorded and/or played back in such a manner may be involve parties that are internal and/or external to such business or institution. Also, this arrangement may not include an ACD capability. In still another example, a phone service provides one or more parties to a call the ability to record, select among previous recordings, and playback a selected recording.

Alternatively or additionally, the present invention can be used with recordings that are aural in the case of a telephonic form of communication and/or visual in the case of an image-based form of communication channel. The communication channel can be based on standard Public Switched Telephone Network (PSTN) telephone lines, wireless telephone, and/or a publicly accessible computer network, such as the internet, to provide voice or another aurally-perceived form of communication, and/or still image, moving picture, or video communication forms, to name just a few examples.

Another embodiment of the present invention includes a method, comprising: at a contact center, receiving a telephone call from a customer and routing the telephone call to an agent of the contact center through a telephonic communication channel established between the customer and the agent with an automatic communication distributor provided with computerized telephony equipment. In response to information spoken by the customer during the telephone call, the agent selects a recording from among a number of different recordings with an agent station of the contact center. The recording is played over the communication channel in response to input from the agent station, the contact center agent and the customer both receiving the recording and communicating with one another over the communication channel during said playing.

Yet another embodiment of the present invention includes a method, comprising: establishing a communication channel between an agent of a contact center and a customer with an automatic communication distributor. The agent selects a recording of an earlier communication of the customer with an agent station of the contact center. The recording is played over the communication channel in response to input from the agent station, the contact center agent and the customer both receiving the recording and communicating with one another over the communication channel during said playing.

Yet a further embodiment includes a contact center system, comprising: a number of communication contact center agent stations, the agent stations each including one of a number of the telephone communication devices and one of a number of agent computer terminals; telephonic interface circuitry coupled to a public switched telephone network and each of the telephone communication devices by a corresponding number of contact center telephone lines; and one or more servers coupled to the agent stations by a computer network and the interface circuitry. The one or more servers are operable to provide an automatic communication distributor to establish a telephonic communication channel between a party outside the contact center and a contact center agent corresponding to a respective one of the agent stations. The one or more servers respond to input by the agent with the respective one of the agent stations to select a recording from a recording store provided with the one or more servers and control playback of the recording including at least one of selectively rewinding and fast forwarding the recording. The recording is routed from the recording store through the interface circuitry to both the party and the contact center agent over the telephonic communication channel.

Another embodiment includes a method, comprising: at a contact center, establishing a telephonic communication channel between an agent of the contact center and a customer with an automatic communication distributor, the agent receiving information from the customer over the communication channel; selecting a recording from among a number of different recordings with an agent station of the contact center based on the information. In response to input from the agent station, playback of the recording is controlled over the communication channel, the contact center agent and the customer both receiving the recording and communicating with one another over the communication channel during the playback, said controlling including at least one of selectively repeating, rewinding and fast forwarding the recording.

Yet a further embodiment includes a method that comprises establishing a first communication channel between multiple parties with a communication server; generating a recording of voice communications between the multiple parties over the first communication channel with the server; and playing the recording over a second communication channel established with the server between one of the parties and one or more others. The one of the parties and the one or more others each aurally receive the recording and can vocally communicate over the second communication channel during said playing.

Another embodiment includes an apparatus that comprises: a device encoded with logic executable by one or more processors to: establish a first telephonic communication between a first party and a second party, generate and store a recording of the first telephonic communication, establish a second telephonic communication between the first party and the second party after the recording is stored, and control playback of the recording to the first party and the second party during the second telephonic communication in response to input from the first party. The first party and the second party aurally receive the recording and can communicate with each other during the playback of the recording.

Yet another embodiment includes a contact center system that comprises: several communication workstations each including a computer and a telephone; telephonic interface circuitry coupled to a public switched telephone network and to the telephone of each of the workstations by a respective one of a number of telephone lines; and one or more servers coupled to the interface circuitry and to the computer of each of the workstations by a computer network. The one or more servers are operable to: establish a first communication channel between a first party and a second party, generate and store a recording of vocal communications of the first party and the second party over the first communication channel, establish a second telephonic communication channel between the first party and the second party after the recording is stored, select the recording from among a number of stored recordings, and control playback of the recording to the first party and the second party over the second telephonic communication channel in response to input from a respective one of the workstations corresponding to the first party. The first party and the second party aurally receive the recording and can communicate with each other during the playback of the recording.

All publications, patents, and patent applications cited in this specification are herein incorporated by reference as if each individual publication, patent, or patent application were specifically and individually indicated to be incorporated by reference and set forth in its entirety herein. While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. A method, comprising:
at a contact center, receiving a telephone call from a customer;
routing the telephone call to an agent of the contact center through a telephonic communication channel established between the customer and the agent with an automatic communication distributor provided with computerized telephony equipment;
in response to information spoken by the customer during the telephone call, the agent selecting a recording from among a number of different recordings with an agent station of the contact center; and
playing the recording over the communication channel in response to input from the agent station, the contact center agent and the customer both receiving the recording and communicating with one another over the communication channel during said playing.

2. The method of claim 1, wherein the recording is of an earlier communication of the customer with the contact center.

3. The method of claim 2, wherein the recording includes an authorization message from the customer.

4. The method of claim 1, which includes at least one of pausing, rewinding, and fast forwarding the recording in response to one or more commands entered with the agent station by the agent.

5. The method of claim 1, wherein the contact center includes one or more servers defining the automatic communication distributor to route communications based on agent availability and at least one agent skill.

6. A method, comprising:
establishing a communication channel between an agent of a contact center and a customer with an automatic communication distributor;
the agent selecting a recording of an earlier communication of the customer with an agent station of the contact center; and
playing the recording over the communication channel in response to input from the agent station, the contact center agent and the customer both receiving the recording and communicating with one another over the communication channel during said playing.

7. The method of claim 6, wherein the communication channel is of a telephonic type and the recording is of a voice type.

8. The method of claim 6, wherein the recording includes an authorization message from the customer.

9. The method of claim 6, which includes at least one of pausing, rewinding, and fast forwarding the recording in response to one or more commands entered with the agent station by the agent.

10. The method of claim 6, wherein the contact center includes:
one or more servers operable to provide the automatic communication distributor and the different recordings, the agent station being coupled to the one or more servers by a computer network;
interface circuitry coupled between a public switched telephone network and the one or more servers, the interface circuitry including a number of contact center telephone lines; and
several agent stations each including a respective one of a number of computers coupled to the computer network and a respective one of a number of telephone communication devices, the telephone communication devices each being coupled to a respective one of the contact center telephone lines of the interface circuitry, the agent station being one of the several agent stations.

11. A contact center system, comprising:
a number of communication contact center agent stations, the agent stations each including one of a number of the telephone communication devices and one of a number of agent computer terminals;
telephonic interface circuitry coupled to a public switched telephone network and each of the telephone communication devices by a corresponding number of contact center telephone lines; and
one or more servers coupled to the agent stations by a computer network and the interface circuitry, the one or more servers being operable to provide an automatic communication distributor to establish a telephonic communication channel between a party outside the contact center and a contact center agent corresponding to a respective one of the agent stations, the one or more servers being responsive to input by the agent with the respective one of the agent stations to select a recording from a recording store provided with the one or more servers and control playback of the recording including at least one of selectively rewinding and fast forwarding the recording, the recording being routed from the recording store through the interface circuitry to both the party and the contact center agent over the telephonic communication channel.

12. The system of claim 11, further comprising means for recording a communication between the party and the contact center agent.

13. The system of claim 11, wherein the one or more servers are further operable to selectively pause and repeat the recording in response to the input.

14. The system of claim 11, wherein the one or more servers include means for identifying the recording as an earlier communication of the party.

15. The system of claim 11, wherein each of the stations includes a respective one of a number of displays, and is operable to present a graphical user interface with several controls for selection and playback of the recording from among a number of different recordings stored on the recording store.

16. A method, comprising:
at a contact center, establishing a telephonic communication channel between an agent of the contact center and a customer with an automatic communication distributor, the agent receiving information from the customer over the communication channel;
selecting a recording from among a number of different recordings with an agent station of the contact center based on the information; and
in response to input from the agent station, controlling playback of the recording over the communication channel, the contact center agent and the customer both receiving the recording and communicating with one another over the communication channel during the playback, said controlling including at least one of selectively repeating, rewinding and fast forwarding the recording.

17. The method of claim 16, wherein the recording is of an earlier communication of the customer with the contact center.

18. The method of claim 17, which includes at least one of pausing, rewinding, and fast forwarding the recording in response to one or more commands entered with the agent station by the agent.

19. The method of claim 17, wherein the contact center includes one or more servers defining the automatic communication distributor to route communications based on agent availability and at least one agent skill.

20. A method, comprising:
establishing a first communication channel between multiple parties with a communication server;
generating a recording of voice communications between the multiple parties over the first communication channel with the server; and
playing the recording over a second communication channel established with the server between one of the parties and one or more others, the one of the parties and the one or more others each aurally receiving the recording and vocally communicating over the second communication channel during said playing.

21. The method of claim 20, wherein at least one of the one or more others is also a member of the multiple parties, and the first communication channel and the second communication channel are each of a telephonic type.

22. The method of claim 20, which includes the one of the parties providing an input to the server to cause said playing.

23. The method of claim 20, wherein the multiple parties number two, the one or more others number one, and another of the multiple parties is the same as one or more others.

24. The method of claim 20, wherein the first communication channel and the second communication channel are each of a telephonic type and which includes selecting the recording from among a plurality of recordings stored with the server by providing an input to the server with a workstation, the workstation being operatively coupled to the server with a computer network.

25. The method of claim 24, which includes at least one of pausing, rewinding, and fast forwarding the recording in response to one or more commands entered by the one of the multiple parties with the workstation.

26. The method of claim 25, which includes in response to input from the one of the parties with the workstation, selecting and playing another recording from among the recordings stored with the server.

27. The method of claim 24, wherein the recording includes a communication from another of the multiple parties who also is included among the one or more others.

28. An apparatus, comprising: a device encoded with logic executable by one or more processors to: establish a first telephonic communication between a first party and a second party, generate and store a recording of the first telephonic communication, establish a second telephonic communication between the first party and the second party after the recording is stored, and control playback of the recording to the first party and the second party during the second telephonic communication in response to input from the first party, the first party and the second party aurally receiving the recording and communicating with each other during the playback of the recording.

29. The apparatus of claim 28, wherein the device includes a removable memory device carrying a number of processor executable instructions to define the logic.

30. The apparatus of claim 29, wherein the removable memory device includes a disk.

31. The apparatus of claim 28, wherein the device is in the form of one or more parts of a computer network carrying one or more signals encoding the logic.

32. A system, comprising:
several communication workstations each including a computer and a telephone;
telephonic interface circuitry coupled to a public switched telephone network and to the telephone of each of the workstations by a respective one of a number of telephone lines; and
one or more servers coupled to the interface circuitry and to the computer of each of the workstations by a computer network, the one or more servers being operable to: establish a first communication channel between a first party and a second party, generate and store a recording of vocal communications of the first party and the second party over the first communication channel, establish a second telephonic communication channel between the first party and the second party after the recording is stored, select the recording from among a number of stored recordings, and control playback of the recording to the first party and the second party over the second telephonic communication channel in response to input from a respective one of the workstations corresponding to the first party, the first party and the second party aurally receiving the recording and communicating with each other during the playback of the recording.

33. The system of claim 32, wherein the one or more servers are responsive to input with a software interface of the respective one of the workstations to pause, rewind, and fast forward the recording.

34. The system of claim 32, wherein the one or more servers include means for identifying the recording as an earlier communication including the second party.
